(19) United States
(12) Patent Application Publication
(10) Pub. No.: US 2020/0010135 A1
(43) Pub. Date: Jan. 9, 2020

(54) Bicycle Saddle

(71) Applicant: Ergon International GmbH, Koblenz (DE)

(72) Inventors: Franc Arnold, Koblenz (DE); Andreas Krause, Koblenz (DE)

(21) Appl. No.: 16/129,059

(22) Filed: Sep. 12, 2018

(30) Foreign Application Priority Data
Jul. 5, 2018 (DE) 20 2018 003 121.6

(51) Int. Cl. B62J 1/26; B62J 1/00

(52) U.S. Cl. CPC B62J 1/26; B62J 1/005; B62J 1/007

(57) ABSTRACT

A bicycle saddle includes a saddle shell, a saddle frame being arranged on the lower side thereof. A saddle cushion is arranged on an upper side of the saddle shell, the saddle cushion including at least two cushion elements. The main cushion element is connected with the upper side of the saddle shell. Auxiliary cushion elements are arranged in recesses of the main cushion element. Both the main cushion element and the at least one auxiliary cushion element include EVA (ethylene vinyl acetate).

### CROSS-REFERENCE TO RELATED APPLICATION

This application claims priority to German Utility Model Application No. 20 2018 003 121.6 filed Jul. 5, 2018, the disclosure of which is hereby incorporated in its entirety by reference.

### BACKGROUND OF THE INVENTION

### Field of the Invention

The invention relates to a bicycle saddle.

### Description of Related Art

Bicycle saddles comprise a saddle shell whose lower side is usually connected with a saddle frame. A saddle cushion is arranged on the upper side of the saddle shell. Typically, saddle cushions are made of foamed material, such as PU foam. The saddle cushions are glued to the upper side of the saddle shell. Such in particular foamed saddle cushions have good damping properties. However, in particular during longer rides, the cushion may be compressed such that in particular the seat bones of a user press upon the upper side of the saddle shell so that pressure marks are formed. The reason for this is that the so-called rebound of such saddle cushions is small. Therefore, it is known place gel cushions in the seat area, i.e. in the rear areas of the bicycle saddle in which the seat bones of the user are arranged. Such insert elements filled with a gelatin- or gel-like material are placed into recesses of the saddle cushion. Thereafter, the seat cushion, as well as the inserted gel elements are covered with a textile element or the like. Such gel elements only achieve a limited enhancement of the sitting comfort, since the gel elements merely cause a better distribution of the forces occurring. Further, gel elements or gel paddings have a drawback in that they are not compressible, but that the gel material can only be displaced. A damping or even rebound properties cannot be obtained through gel paddings.

### SUMMARY OF THE INVENTION

It is an object of the invention to provide a bicycle saddle with improved sitting comfort.

A bicycle saddle comprises a saddle shell typically mad of hard plastic material. A saddle frame is arranged at the lower side of the saddle shell. The saddle frame serves for connection with the saddle support tube, wherein the saddle frame may also be integrally formed with the support tube. With common saddles, the saddle frame is an element made of metal bars that is connected both with a saddle tip directed in the traveling direction and with the rear of the saddle. Other connections between the saddle shell and the saddle frame or a connecting element to the saddle support tube corresponding to the saddle frame are known as well. A saddle cushion is arranged on the upper side of the saddle shell. The same may be glued onto the upper side of the saddle shell or may be connected directly with the upper side of the saddle shell already during manufacturing, using corresponding manufacturing techniques.

With bicycle saddles according to the invention, the saddle cushion comprises at least two cushion elements. The cushion elements serve in particular to dampen the movements occurring when riding a bicycle, as well as to support the user in the most comfortable manner possible. The cushion elements may also be made of different materials, wherein the corresponding elements serving in particular for dampening and support.

The saddle cushion according to the invention comprises a main cushion element and at least one auxiliary cushion element. The main cushion element is connected with the upper side of the saddle shell. The at least one auxiliary cushion element is arranged in a corresponding recess provided in the main cushion element. According to the invention, the at least one auxiliary cushion element includes EVA (ethylene vinyl acetate). Preferably, the main cushion element also includes EVA. It is particularly preferred that the main cushion element and/or the at least one auxiliary cushion element are made of EVA.

It is preferred that the main cushion element and the at least one auxiliary cushion element have different characteristics, in particular different damping characteristics, rebound characteristics and pressure distribution characteristics.

In a particularly preferred embodiment of the invention the damping characteristics of the at least one auxiliary cushion element are higher or better than the damping characteristics of the main cushion element. In particular, the damping characteristics of the at least one auxiliary cushion element are at least 20%, preferably at least 30% and particularly preferred at least 50% higher than the damping characteristics of the main cushion element.

It is further preferred that the rebound characteristics of the at least one auxiliary cushion element are better than the rebound characteristics of the main cushion element. In particular, the rebound characteristics of the at least one auxiliary cushion element are at least 20%, preferably at least 30% and particularly preferred at least 50% better than the rebound characteristics of the main cushion element.

In a preferred development of the invention the material is selected such that the pressure distribution characteristics of the at least one auxiliary cushion element are more homogenous, i.e. a more homogenous distribution of the pressure is provided than by the main cushion element. The homogeneity is better by at least 20%, preferably at least 30% and particularly preferred at least 50%.

The at least one auxiliary cushion element is preferably made of higher quality EVA than the main cushion element.

It is particularly preferred that the at least one auxiliary cushion element is made by punching or cutting.

The main cushion element is preferably made by foaming or swelling in the mold in which also the saddle is placed.

Manufacturing the main cushion elements by foaming is possible in particular, if the main cushion element is made from a foamable material such as PU. If the main cushion element is made from an EVA material, manufacturing is performed in a separate process step.

The at least one auxiliary cushion element is preferably fixed in the corresponding recess. This may be effected using a bonding agent, in particular by gluing.

It is further preferred that an in particular common cover layer is provided on the outer side of the main element and the at least one auxiliary cushion element, and that in particular the cushion elements are covered with a common cover layer. Preferably, the cover layer is fixed, in particular glued to a lower side of the saddle shell. The cover layer preferably comprises textile, in particular water-impermeable material and is, as is particularly preferred, made from such material.

The invention will be explained in more detail hereunder with reference to a preferred embodiment and to the accompanying drawings.

### BRIEF DESCRIPTION OF THE DRAWINGS

In the Figures:

FIG. 1 is a schematic top plan view of a bicycle saddle,

FIG. 2 is a schematic sectional view along line II-II in FIG. 1, and

FIG. 3 is a schematic sectional view along line III-III in FIG. 1.

### DESCRIPTION OF THE INVENTION

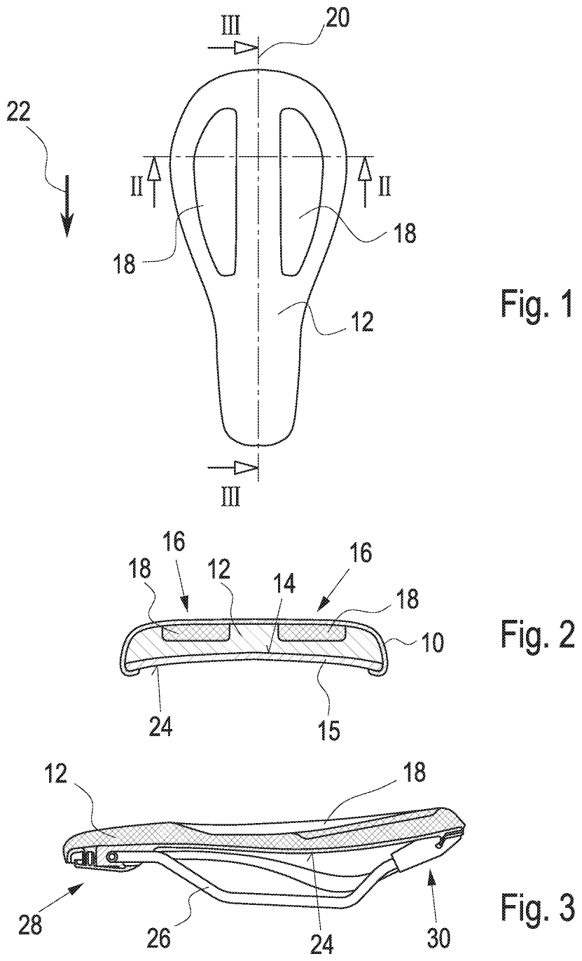

The bicycle saddle shown in top plan view in FIG. 1 is illustrated in FIG. 1 without a cover layer 10 (FIG. 2) for clarity. A main cushion element 12 is arranged underneath the cover layer 10, which element extends in particular over the entire upper side 14 (FIG. 2) of a saddle shell 15. In the embodiment illustrated, the main cushion element 12 has two recesses 16 in which one auxiliary cushion element 18 is arranged, respectively. The two auxiliary cushion elements 18, which are made in particular of higher quality EVA than the main cushion element 12, are arranged in the seat area of the saddle, in particular in the area of the two seat bones.

The two auxiliary cushions 18 are arranged symmetrically with respect to a longitudinal axis 20 of the bicycle saddle and extend in the longitudinal direction 22 of the bicycle saddle.

For the protection of the cushion elements 12, 18 in particular against humidity, the same are covered by a humidity-impermeable cover layer 10. The cover layer 10 is fastened to a lower side 24 of the saddle shell, in particular by gluing.

Further, a saddle frame 26 (FIG. 3) is provided on the lower side 24 of the saddle shell. The saddle frame 26 which in particular comprises two saddle bars, is connected with the saddle tip in the area 28 and with a rear edge portion of the saddle in the area 30.

1. A bicycle saddle comprising:
a saddle shell;
a saddle frame connected with a lower side of the saddle shell;
a saddle cushion arranged on an upper side of the saddle shell, the saddle cushion comprising at least two cushion elements, including
a main cushion element connected with the upper side of the saddle shell; and
at least one auxiliary cushion element arranged in at least one recess of the main cushion element, the auxiliary cushion element including EVA (ethylene vinyl acetate).

2. The bicycle saddle of claim 1, wherein the main cushion element includes EVA (ethylene vinyl acetate).

3. The bicycle saddle of claim 1, wherein at least one of the main cushion element or the at least one auxiliary cushion element is made of EVA.

4. The bicycle saddle of claim 1, wherein the at least one auxiliary cushion element has better damping characteristics than the main cushion element, the damping characteristics being better by at least 20%.

5. The bicycle saddle of claim 1, wherein the auxiliary cushion element has better rebound characteristics than the main cushion element, the rebound characteristics being better by at least 20%.

6. The bicycle saddle of claim 1, wherein the pressure distribution characteristics of the at least one auxiliary cushion element are better than the pressure distribution characteristics of the main cushion element, the pressure distribution being in particular more homogenous.

7. The bicycle saddle of claim 1, wherein the at least one auxiliary cushion element is made of higher quality EVA than the main cushion element.

8. The bicycle saddle of claim 1, wherein the at least one auxiliary cushion element is made by punching or cutting.

9. The bicycle saddle of claim 1, wherein the at least one auxiliary element is glued into the recesses.

10. The bicycle saddle of claim 1, wherein an in particular common cover layer is glued onto an outer side of the main cushion element and/or the auxiliary cushion element.

11. The bicycle saddle of claim 1, wherein the main cushion element has a plurality of recesses in which one of the at least one auxiliary cushion elements is arranged, respectively.

12. The bicycle saddle of claim 1, wherein the at least one auxiliary cushion element is arranged in the seat area.

13. The bicycle saddle of claim 1, wherein the at least one auxiliary cushion comprises two auxiliary cushion elements arranged side by side in the seat area, in particular at a distance from each other.

14. The bicycle saddle of claim 1, wherein the at least one auxiliary cushion element has better damping characteristics than the main cushion element, the damping characteristics being better by at least 30%.

15. The bicycle saddle of claim 1, wherein the at least one auxiliary cushion element has better damping characteristics than the main cushion element, the damping characteristics being better by at least 50%.

16. The bicycle saddle of claim 1, wherein the auxiliary cushion element has better rebound characteristics than the main cushion element, the rebound characteristics being better by at least 20%.

17. The bicycle saddle of claim 1, wherein the auxiliary cushion element has better rebound characteristics than the main cushion element, the rebound characteristics being better by at least 30%.

18. The bicycle saddle of claim 1, wherein the auxiliary cushion element has better rebound characteristics than the main cushion element, the rebound characteristics being better by at least 50%.
